(19) United States
(12) Patent Application Publication
(10) Pub. No.: US 2003/0139994 A1
(43) Pub. Date: Jul. 24, 2003

(54) Financial institution system

(76) Inventor: John E. Jones, Winnetka, IL (US)

Correspondence Address: JENKENS & GILCHRIST, P.C., 225 WEST WASHINGTON, SUITE 2600, CHICAGO, IL, 60606, US

(21) Appl. No.: 10/348,819

(22) Filed: Jan. 22, 2003

Related U.S. Application Data
(60) Provisional application No. 60/350,588, filed on Jan. 22, 2002.

(51) Int. Cl. G06F 17/60

(52) U.S. Cl. 705/36

(57) ABSTRACT

A financial institution system, including a financial institution terminal. The financial institution terminal includes a document imaging device that obtains an image of a personal identification document, which has a photograph of the person. An image taking device that obtains an image of a person who presented the personal identification document to the financial institution terminal is also included in the financial institution terminal. The system further includes a processor that receives the document image and person image from the financial institution terminal for review and further operates to perform a financial institution function requested by the person if it is determined that the photograph in the document image and the person image appear to be of the same person.

### RELATED APPLICATION

This application claims priority to U.S. Provisional Patent Application No. 60/350,588, filed on Jan. 22, 2002, incorporated herein by reference in its entirety.

### FIELD OF THE INVENTION

The field of the invention relates generally to an image scanning system and, specifically, to systems whereby accounts are administered from information obtained from a remote site.

### BACKGROUND OF THE INVENTION

In years past, a customer had to travel to a bank to conduct any banking business, such as opening/closing an account, depositing/withdrawing funds, or transferring money between accounts. Since banks were only open a limited amount of time, usually during standard business hours and during the morning on Saturdays, this was a great inconvenience for many people. To combat this problem, banks increased their hours of operation. There were still times, however, when people wanted to conduct transactions, but were unable to travel to the bank during the hours of operation.

One solution banks instituted was the Automated Teller Machine (ATM), which allows a customer access to his or her bank account at a location remote from the bank or while the bank is closed. ATMs allow customers limited access to their accounts, e.g., they may deposit, withdraw, or transfer funds. A customer using an ATM inserts a card which contains information about them, e.g., name, bank name, bank account number. The ATM then prompts the customer to input an access code, or personal identification number (PIN). After the customer submits the PIN, the ATM contacts the customer's bank for verification. Once verification occurs, the customer may select any one of a number of functions. Some of these functions include debiting and crediting an account. After the customer makes a selection, the ATM processes the transaction by either dispensing or accepting funds, assuming the transaction is approved by the bank. The ATM then electronically notifies the customer's bank of the transaction. If funds were deposited, the deposits are subsequently manually taken from the ATM and given to the customer's bank for processing.

The ATM does not, however, allow a customer to perform administrative functions, such as opening a new account, closing an existing account, and changing customer information, all activities which still requires the customer to travel to the bank. For many customers, this is inconvenient because oftentimes they cannot go to the bank during its hours of operation. Thus, there is a need for a device which allows customers to perform administrative functions on an account at a location remote from a bank.

### SUMMARY OF THE INVENTION

According to one embodiment of the present invention, a financial institution system includes a financial institution terminal. The financial institution terminal includes a document imaging device that obtains an image of a personal identification document, which has a photograph of the person. An image taking device that obtains an image of a person who presented the personal identification document to the financial institution terminal is also included in the financial institution terminal. The system further includes a processor that receives the document image and person image from the financial institution terminal for review and further operates to perform a financial institution function requested by the person if it is determined that the photograph in the document image and the person image appear to be of the same person.

According to another embodiment, a system, comprises a financial institution terminal including a customer identification reader. The customer identification reader obtains a customer identification information from a customer identification card. Further included in the customer identification reader is a person characteristic acquisition device that obtains personal characteristic information regarding a person who presented the customer identification card to the financial institution terminal. The system also includes a processor that receives the customer identification information and personal characteristic information from the financial institution terminal for review and further operates to perform a financial institution function requested by the person if it is determined that the customer identification information and personal characteristic information are consistent with each other.

According to some embodiments, the remote banker also obtains an image of a first signature sample located on the personal identification document and then obtains a signature sample from the person. A comparison of the signature from the imaged document and the person signature is then made, with the result of that comparison used to enable a selected administrative function to be performed.

In another embodiment, a plurality of remote bankers are connected to a processor.

According to another embodiment, the personal banking system may further include a bio-identification reader adapted to obtain at least one image of a part of the customer's body (e.g., finger print or retina scan).

The personal banking system of the present invention is beneficial since it allows a customer to perform administrative functions from a location which is remote from the bank office. The customer does not need to travel all the way to the bank to perform the administrative function. Also, in some embodiments, the customer is not restricted to the bank's hours of operation as to when they can perform the administrative function.

### BRIEF DESCRIPTION OF THE DRAWINGS

The foregoing and other advantages of the invention will become apparent upon reading the following detailed description and upon reference to the drawings.

FIG. 1a is a flowchart describing the operation of a personal banking system according to an embodiment of the present invention.

FIG. 1b is a flowchart describing the operation of the personal banking system according to another embodiment of the present invention.

FIG. 2 is a flowchart describing the operation of the personal banking system according to another embodiment of the present invention.

FIG. 3 is a block diagram of a personal banking system according to an embodiment of the present invention.

FIG. 4 is a block diagram of the components of a remote banker system according to an embodiment of the present invention.

FIG. 5 is a perspective view of a remote banker according to an embodiment of the present invention.

FIG. 6 is a flow chart describing the operation of the personal banking system according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE EMBODIMENTS

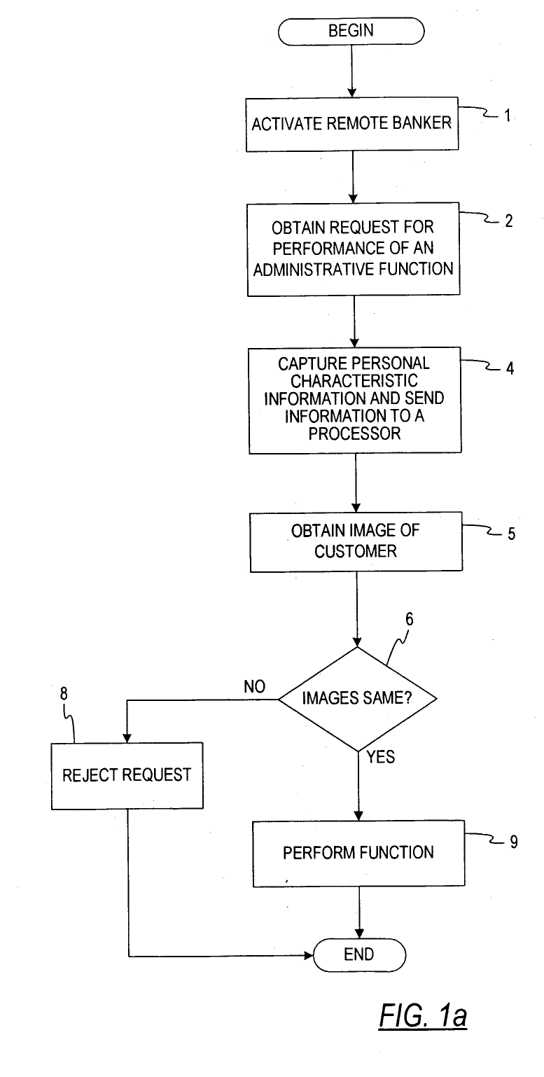

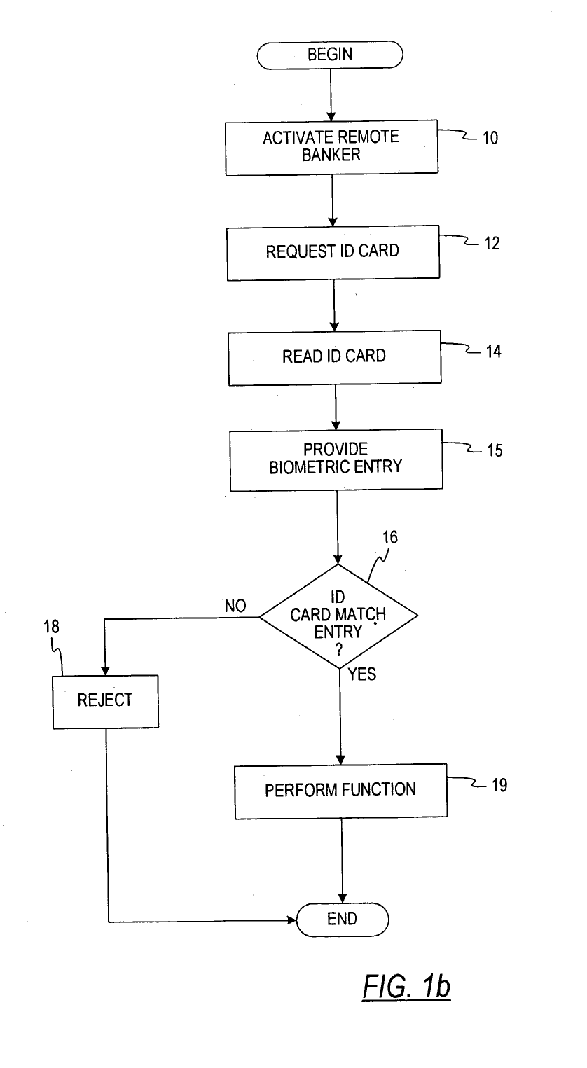

FIG. 1a is a flowchart describing the operation of a personal banking system according to an embodiment of the present invention. A personal banking system of the present invention is designed to allow customers to remotely perform administrative functions (such as open/close accounts and access existing accounts) with respect to a financial institution. The term “financial institution” includes banks, savings and loans, investment houses, credit unions and all other types of financial institutions, whether private, public, or government. The following description is in terms of banks, but the principles of the present invention are applicable to other financial institutions, as well. The term “remote” means that the item, e.g., a remote banker or a remote scanner, is at a location that is physically separate from a processor of a financial institution. For example, the remote banker can be located in a lobby or vestibule at the financial institution, a shopping mall, or a store. The remote banker can even be in a back room of a financial institution, but is physically separate from the processor of the financial institution.

Turning now to FIG. 1a, a person, specifically, a customer desiring to remotely perform administrative functions first activates the remote banker. The remote banker may be activated (step 1) in any number of ways, for example, by a voice command, video recognition, a motion sensor, or pressing a “start” button. The start button may be in the form of a button on a touch screen or it may be an independent, dedicated button. Next, at step 2, the customer requests an administration function to be performed (for example, new account opening). In some embodiments, this is accomplished by inserting an account administration form into the remote banker. Alternatively, the customer may specify the requested administrative function in other ways (such as through a key selection).

At step 4, a personal characteristic acquisition device obtains personal characteristic information and transmitted to a processor where it may be stored. It is also contemplated that the personal characteristic information may be stored at the remote banker. A processor may be any type of processor that is adapted to receive images, open new accounts, and transmit instructions to a remote banker. The processor may be located, for example, at an office of the bank, a processing or operational center of the bank, or a branch office of the bank. The personal characteristic information may be a first image that includes a photograph image and a signature image obtained from an identification-type document. The identification-type document is usually a driver's license, but may be another form of identifying document, such as a passport or state identification card or other type of identification document that has a photograph of the person viewable on the surface. The purpose of the identification-type document is to provide a photograph of the customer and his or her signature. The personal characteristic information may also be information obtained by a biometric scan, such as a fingerprint scan or a retinal scan. Additionally, the personal characteristic information may be information obtained by searching a history file of images stored at the bank. In either of these processes, the personal identification information is obtained which identifies the customer.

Next, at step 5, the remote banker obtains an image of the customer using an image taking device, as the customer stands in the vicinity of the remote banker (i.e., a real time image of the person at the remote banker). The image may be a video image, a still image, a digital image, or any other type of image generally used. The image taken may also be of a variety of views. In one embodiment, only an image of the customer's head and shoulders is taken. In other embodiments, an image of the whole person or just the face may be taken. In yet another embodiment, an operator (defined below) or the remote banker may decide how much of the customer should be imaged.

Once the image of the customer is captured, it may be stored at the remote banker and may then be transmitted to the processor where it may also be stored. In one embodiment, the remote banker may instruct the customer to move so that the image taking device can obtain a more accurate image. The instruction may be given over a speaker included on the remote banker or words on a screen. In another embodiment, the customer may be instructed to stand at a marked position on the floor prior to the image being taken.

At step 6, a comparison is made of the identity of the customer according to the first image and the identity of the customer according to the real-time image to see if they are the same. If the identification-type document or history file is used, the comparison may simply involve comparing the two images and determining whether they represent the same person. This comparison may be done manually by an operator or it may be done by automated software. The term “operator” includes any person who has access to use the system. For example, the “operator” may be a bank teller, a personal banker, a loan administrator, or an independent contractor working for the bank. If the comparison is done by automated software, it is contemplated that according to some embodiments, the software obtains a similarity rating between the two images. The similarity rating may then be compared to a predetermined threshold. If the similarity rating falls below the predetermined threshold, a negative response is generated. Of course, other methods may be utilized in automatically comparing the images. Once the negative response is received, either from the software or by the operator inputting a negative response, the personal banking system advances to step 8 and the request to perform an administrative function is rejected. At this point, according to one embodiment, the identification-type document may be kept by the remote banker and the proper authorities notified. According to another embodiment, it is also contemplated that the remote banker may return the identification-type document to the customer. If the first image is obtained through a biometric scan, the first image will be linked to an identity, and information regarding this identity may include an image of the person, which may be compared to the real-time image. Alternatively, the real-time image may be used to search a database, which produces an identity. The two identities may then be compared, i.e., do both images result in the same name being identified as the customer.

If the comparison at step 6 is positive, meaning it was determined the images represent the same person, the remote banker continues to step 9, where the requested administrative function is performed. For example, the administrative function may comprise opening an account. Opening the account may include setting up files in the banking system and issuing the customer a document, such as an account card or a receipt stating the account number and the bank name or otherwise informing the customer that the account has been opened. Also, in the instance of opening a new account, a deposit may be accepted. The deposit may be in the form of an electronic transfer, currency bill deposit, or deposit of negotiable instruments.

FIG. 1b is a flowchart describing the operation of another embodiment of the personal banking system of the present invention. In this embodiment, the remote banker is activated at step 10. At step 12, the remote banker requests an identification card to be input into the system. The identification card is then read at step 14. The reading of the card can be done in a number of different ways. The card can be read by obtaining an image of the card using a document imaging device. Alternatively, the card can be read by using a magnetic strip reader to obtain information that is encoded in a magnetic strip on the card. Information that is encoded on the magnetic strip may include biometric information about the rightful card owner, such as fingerprint information, retinal scan information, etc. Next, at step 15, the customer is asked to provide a biometric entry. This may be accomplishes by having the customer place his thumb on a thumb pad for a fingerprint scan or having the customer place his eye against a retinal scanner for a retinal scan. The biometric entry is then compared to the biometric information located on the identification card at step 16. If the biometric entry matches the biometric information on the card, the banker proceeds to step 19 and a financial institution function requested by the customer is performed. However, if the biometric entry does not match the biometric information on the card, then the request for financial institution function by the customer is rejected at step 18.

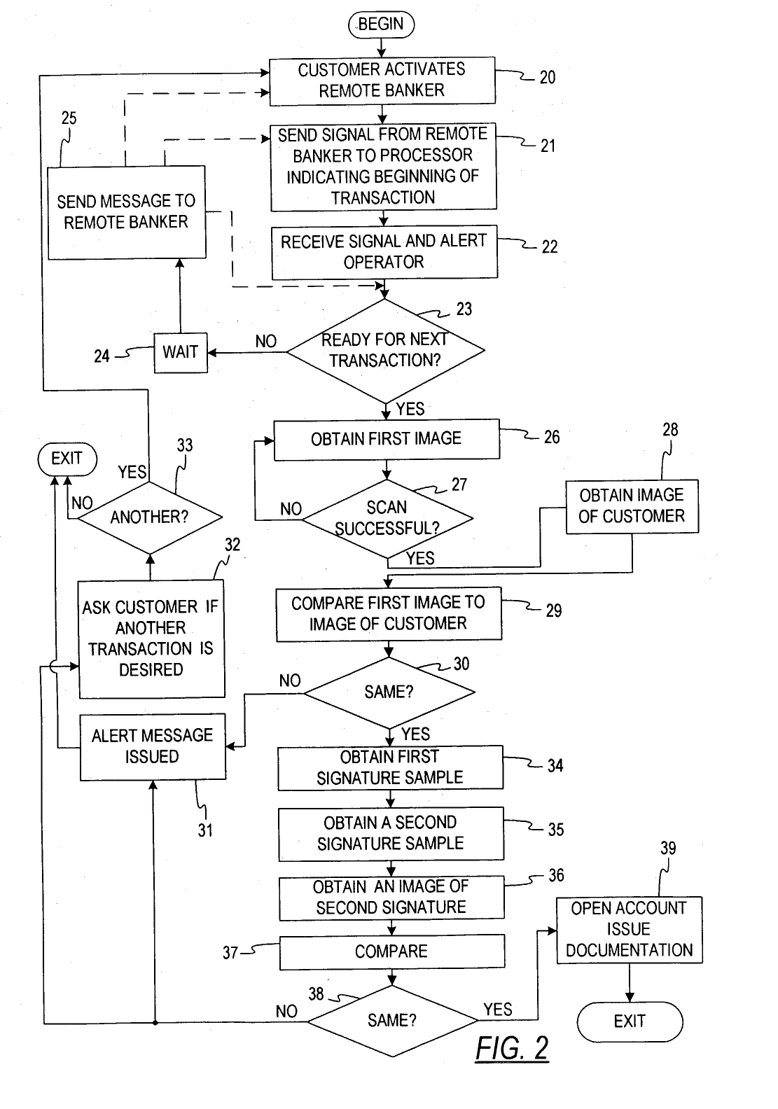

FIG. 2 is a flowchart describing the operation of another embodiment of the personal banking system of the present invention. In one embodiment, the personal banking system includes a remote banker, a processor at a location separate from the remote banker, e.g., a bank office, a link connecting the two, and one or more operators. A customer activates the remote banker by any method described above to begin the transaction (step 20). At step 21, a signal is sent from the remote banker to the processor indicating the beginning of the transaction. At step 22, the processor receives the signal and alerts an operator that it is desired to begin an administrative function.

At step 23, it may be determined whether the processor is ready to process the transaction. For example, the main processor must determine if an operator is available to authorize the performance of the administrative function. If the answer at step 23 is negative, the main processor proceeds to step 24 where the system waits for a predetermined time. The predetermined time may be long enough for an operator to become available. At step 25, a message may be sent to the customer at the remote banker indicating that a waiting period is occurring. The message may also be more detailed if an approximate wait time is known or if it has been determined that no operator will be available for too great a period of time (e.g., it is past the normal operating hours of the bank and no operator is available).

After step 25, it may be required that the system returns to step 20, requiring the customer to reactivate the remote banker to begin the transaction again. Alternatively, the system may move directly to step 21 to send a signal indicating the beginning of a transaction. In another embodiment, the system proceeds from step 25 to step 23 directly and inquires whether the processor is ready to perform an administrative function. After looping through step 25 a predetermined number of times, the processor may be programmed to send a message to the remote banker instructing the remote banker to end the transaction and to inform the customer to try again later.

If the answer at step 23 is affirmative, the system proceeds to step 26. At step 26, the remote banker obtains a first image, thereby identifying the customer. In some embodiments, the customer inserts an identification-type document into the remote banker after being given an instruction to do so from the remote banker. The remote banker then scans the identification-type document. The identification-type document may be any of the documents discussed above in relation to FIG. 1 and has identification information. Identification information may be a photograph, a signature, a social security number, or a driver's license number. The remote banker may obtain an image of the photograph on the identification-type document, the signature on the identification-type document, and any other pertinent information desired to complete the transaction, such as a social security number, address, or driver's license number. Alternatively, the remote banker may obtain the first image by performing a biometric scan. The biometric scan may include obtaining a finger print and/or retinal scan. Alternatively, the remote banker may obtain the first image by searching a history file that contains image information of customers of the bank.

Next, at step 27, the system determines whether the scan has been successful. If the answer at step 27 is negative, the system returns to step 26 where a rescan may be attempted. The system may attempt to rescan for a predetermined number of times or the rescan may be cancelled by either the customer or the operator. If a positive rescan is not obtained, the system may reject the identification-type document, notifying both the operator and the customer of the reason for failure. If the system determines at step 27 that the scan was successful, the system proceeds to step 28 where an image is obtained of the customer (i.e., a real time image of the person at the remote banker). Next, at step 29, a comparison of the first image and the customer image of the customer is performed. The comparison may be done by either the operator at the bank office or by automated software, in order to determine if the images identify the same person, as discussed in reference to FIG. 1.

At step 30, it is determined whether the result of the comparison is positive (i.e., the images are of the same person). If the answer is negative, the system proceeds to step 31 where an alert message may be sent to the appropriate authorities. It is also contemplated that the identification-type document could merely be returned to the customer. At steps 32 and 33, the system may ask the customer to retry by submitting another identification-type document or whether another transaction, such as a balance inquiry, transfer, deposit, or withdrawal on an existing account is desired. If the answer at step 33 is negative, execution halts. If the answer is affirmative, the system returns to step 20 and execution continues as described above.

If the answer at step 30 is affirmative, or yields a positive response, then at step 34, the system obtains a first signature sample. The first signature sample may be obtained from the image of the identification-type document or from a history file that contains signature records. Next, a second signature sample is obtained from the customer at step 35. The second signature sample may be obtained by using a signature acquisition device, such as an electronic pen to create an electronic signature sample or by using a signature card and inserting the signature card into the remote banker. If the customer is instructed to sign a signature card, it is contemplated that a image taking device may record the customer signing the signature card in case of any irregularities. The real-time image of the customer signing the signature card may be viewed at the time of signing or it may be recorded and viewed at a later date. Videotaping the signing of the signature card helps lessen the likelihood that someone will perform administrative functions on someone else's account (e.g., open an account in someone else's name, change signer's on another person's account, etc . . . ). The signature card may be supplied to the customer on or near the remote banker and may be of the type commonly known in the art. Once the second signature sample is obtained, an image of the second signature sample may be taken at step 36. Next, at steps 37 and 38, a comparison between the image of the second signature sample and the image of the first signature sample may be made. The comparison may be made by either the operator or an automated software program as described above. If the answer at step 38 is negative, the system proceeds to step 31 and execution continues as described above. If, at step 38, the comparison yields a positive response (i.e., that the images of the signatures match), then the system proceeds to step 39 where the administrative function is performed, e.g., the new account is opened. In the case of a customer opening a new account, new account identification documentation may be issued to the customer, such as an account card, savings book, or receipt listing the new account number.

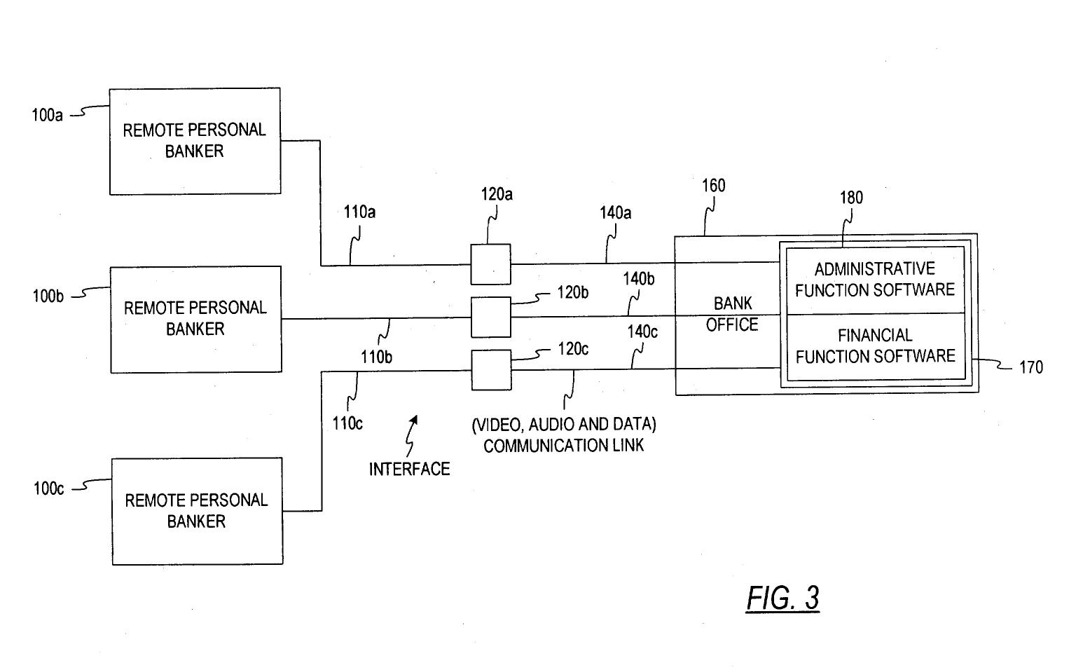

Referring now to FIG. 3, a block diagram of a personal banking system according to one embodiment of the present invention is shown. The system comprises a plurality of remote bankers 100a, 100b, 100c. The remote bankers 100a, 100b, 100c may be located together, such as in a vestibule in a bank or in a shopping mall, or they may be located at sites separate from each other, such as one in a particular store and another in a different store, bank lobby, shopping mall, or office building. A customer may use one of the remote bankers 100a, 100b, 100c to perform desired financial institution function, i.e., administrative and/or financial functions (such as, for example, access an existing account or open an account at a financial institution). It should be noted that one or more of the remote bankers 100a, 100b, 100c may be implemented as, in connection with, or in association with, an automated teller machine (ATM) and thus, additionally possesses the functionalities commonly associated with such machines (deposit, withdrawal, balance inquiry, transfer, fill pay, check request, and the like).

Each of the plurality of remote bankers 100a, 100b, 100c are connected to an interface 120a, 120b, 120c, respectively. Each remote banker 100a, 100b, 100c may send audio, video, and/or data signals over respective communication links 110a, 110b, 110c to the corresponding interfaces 120a, 120b, 120c. The signals can be in any format, including packets, cells, frames, or simple analog and digital signals as is known in the art. The purpose of the interfaces 120a, 120b, 120c is to perform any needed conversions so that the audio, video, and/or data signals can be transmitted over outside communication links 140a, 140b, 140c. The outside communication links 140a, 140b, 140c may be any link used for data, voice, or video communications that is known in the art, such as a cable line or telephone line. Additionally, the communication links 140a, 140b, 140c may transmit data over another form of media, such as a radio or microwave link. The interfaces 120a, 120b, 120c may also provide multiplexing for the signal received over communication links 110a, 110b, 110c.

The communication links 140a, 140b, 140c are coupled at a bank office 160 to a processor 170 which has facilities to receive and convert the signals into a useable form by any other processors which may be used in performing both administrative and/or financial functions at the bank. It is contemplated that the interfaces 120a, 120b, 120c may be located at any point between the remote bankers 100a, 100b, 100c and the processor 170. Their location on FIG. 3 is merely for convenience.

The processor 170 also has software 180 used for administrative and/or financial functions. The software 180 may be stored in a computer memory in the processor 170. The software 180 may also be stored outside the computer memory of the processor and then uploaded as it is needed. The computer memory may either be a single computer memory or multiple computer memories. The purpose of the software 180 is to allow an operator of the processor 170 to perform administrative and/or financial functions as requested by a customer via a remote banker 100a, 100b, 100c. The software 180 may be adapted to create files and communicate with the remote bankers 100a, 100b, 100c. For example, if the function to be performed is opening a new account, the software establishes the new account and can convey new account identification to the customer.

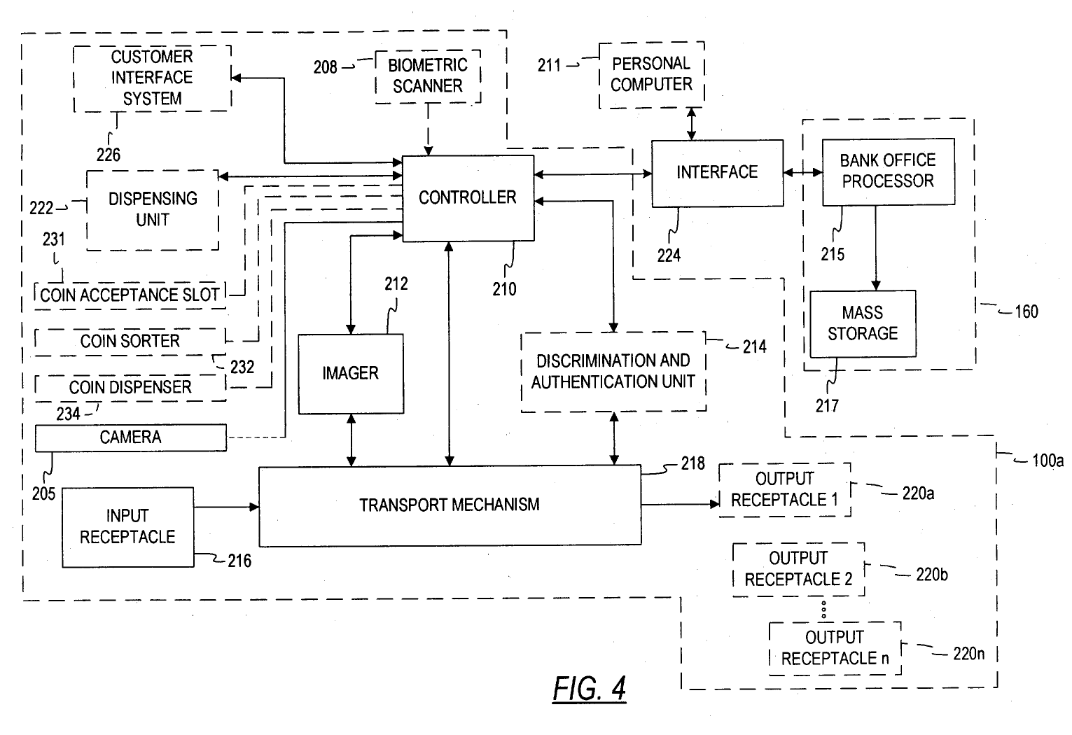

FIG. 4 shows a block diagram of the components of a personal banking system having the remote banker 100a and the bank office 160 of FIG. 3, according to one embodiment of the present invention. An input receptacle 216 is provided to allow for the receipt and processing of documents. The documents may be financial institution documents, bills, or any other document that a customer needs to provide to a bank. The term “bills” includes conventional U.S. and foreign bills, such as $1 bills. The term “financial institution documents” includes checks, deposit slips, account administration forms (e.g., to open/close accounts, change address, add signers, etc . . . ) coupon and loan payment documents, food stamps, cash tickets, savings withdrawal tickets, check deposit slips, and savings deposit slips. Other examples of documents include personal identification-type documents such as a driver's license, passport, state identification card, signature card, and any other documents capable of providing identification information. Additional types of documents which may be processed according to the present invention include loan applications, credit card applications, student loan applications, accounting invoices, debit forms, account transfer forms, and all other types of forms with predetermined fields. In some embodiments, the input receptacle is adapted to receive currency bills and/or negotiable instruments such as checks for deposit. The deposits may be made into new and/or existing accounts at the financial institution.

A transport mechanism 218 transports the received documents one by one from the input receptacle 216 past an imager 212, which obtains a document image. Obtained images may be transmitted to the processor 215. For example, if a customer is attempting to open a new account, a driver's license may be imaged. The image of the driver's license will be transmitted to the processor 215 for examination. The image from the second identification-type document (e.g., a signature card) may also be transmitted in the same manner.

The imager 212 may contain an optical character recognition (OCR) software (not shown) which may recognize certain fields within the document and process information contained within these fields. For example, the imager 212 may obtain the full image of the document, and the OCR may search the full image of a driver's license for a signature field and store the signature for later use by the system. The OCR may also search for serial numbers in currency bills and/or account numbers in checks. In another embodiment, only the relevant portions of the documents will be imaged and/or transmitted to the processor 215. For example, the imager 212 may be adapted so that only the photograph and signature are imaged from a driver's license and only these images are transmitted to the processor 215. The system may also be used to capture any image for electronic document display, electronic document storage, electronic document transfer, electronic document recognition (such as denomination recognition or check amount recognition), or any other processing function that can be performed using an electronic image. The imager may be of the type described in U.S. Pat. Nos. 5,023,782, 5,237,158, 5,187,750, and 4,205,780, all of which are incorporated herein by reference in their entireties. The imager can also be a color imager such as the type described in U.S. Pat. No. 5,335,292, which is incorporated herein by reference in its entirety.

The remote banker 100a also includes an image taking device, such as a camera 205. The camera 205 is adapted to obtain a live image of the customer as the customer is operating the remote banker 100a. The camera may obtain a still image, a video image, and/or a digital image of the customer. The live image or person image obtained by the camera is transmitted from the customer imager to the processor 160 for review as described above in relation to FIGS. 1 and 2.

In some embodiments, the remote banker 100a also includes a biometric scanner 208. The biometric scanner 208 may be a retinal scanner, a fingerprint scanner or any other biometric scanner known in the art. The biometric scanner 208 is adapted to scan a part of the customer's body, such as the retina and/or fingerprint, in order to identify the customer. The biometric scanner 208 may be used in conjunction with the camera and/or the imager 212 in order to positively identify a customer using the remote banker. The biometric scanner 208 may be of the type described in U.S. Pat. No. 5,469,506, U.S. Pat. No. 6,333,988 B1, and U.S. Pat. No. 4,752,966, all of which are incorporated by reference in their entirety.

The transport mechanism 218 may be adapted to transport the document past a discrimination and authentication unit 214. The discrimination and authentication unit 214 may be of the type described in U.S. patent application Ser. No. 09/059,813 and corresponding published PCT application WO 98/47100 and U.S. Pat. No. 5,815,592, all of which are incorporated herein by reference in their entirety. The discrimination and authentication unit 214 authenticates the document and, in the case of a bill, determines the denomination of the bill. With other documents, such as checks, the system may capture information such as the check number, transaction amount, account number, or bank number. The discrimination and authentication unit 214 may also direct the transport unit 218 to place the document in one of the output receptacles 220a-n as described below.

In one embodiment, the discrimination and authentication unit 214 may be programmed to check the validity of the first identification-type document to ensure its validity. For example, the remote banker 100a may first request that the customer identify the type of document being inserted (driver's license, state identification card, or passport). Then the discrimination and authentication unit 214 may compare features of the first identification-type document to features commonly found in those types of identification documents, such as holograms, bar codes, formats, etc.

In another embodiment, the discrimination and authentication unit 214 does not analyze identification-type documents such as driver's licenses, state identification cards, passports and signature cards. For example, in some situations, the discrimination and authentication unit 214 simply recognizes documents such as a driver's license and signature card as being of a type where discrimination or authentication need not be performed. In this case, after the discrimination and authentication unit 214 recognizes the identification-type document as such, the transport mechanism 218 returns the document to the customer through the output receptacle 220a. It is also contemplated that the identification-type documents can be returned by the transport mechanism 218 via the input receptacle 216.

In some embodiments, it is contemplated that the discrimination and authentication unit 214 may not be included in the remote banker 100a, 100b, 100c. In such embodiments, the documents are transported past the imager 212, analyzed based on the output of the imager 212, and then returned to the customer via either the input or output receptacles 216, 220a-n.

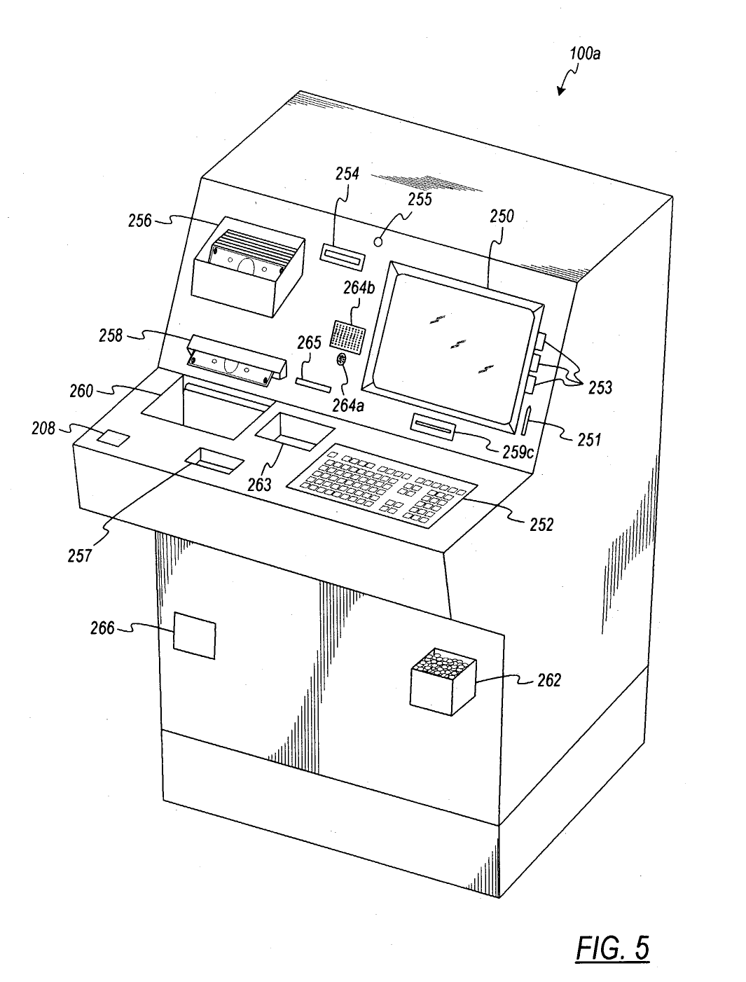

Many other modules may be added to the remote banker 100a to enable the banker to perform additional functions. In some embodiments, it may be desirable that the remote banker 100a be able to perform functions similar to a standard ATM. In fact, in some embodiments, the remote banker is a modified ATM, as shown in FIG. 5. In other embodiments, it may also be desirable that the remote banker 100a be able to scan and process other documents, such as currency bills, checks, deposit slips, loan forms, invoices, etc. In many of these embodiments, a dispensing unit 222 (FIG. 4) may be included in the remote banker 100a and used for a variety of purposes. The dispensing unit 222 may be used to dispense receipts and account books to a customer who just opened a new account or performed a transaction using the remote banker. Also, the dispensing unit 222 may dispense funds to a customer when required. For example, when the customer is depositing currency in an account (after the account has been opened), the system may have the capability to return all or part of a deposit back to the customer in the form of bills, coins, or other media via the dispensing unit 222.

The dispensing unit 222 may be capable of dispensing or updating a variety of media, such as money orders, smart cards, and/or checks, and may include separate units directed to dispensing or updating a particular type of media. The system may also have to wait for a certain period of time before dispensing funds from or to an account. For example, not all deposits may be available for immediate withdrawal. For example, banks may require that checks deposited in new accounts be held for a predetermined number of days.

In another embodiment, there may also be included a coin sorter 232 and a coin dispenser 234 for sorting and/or dispensing coins for a customer desiring coins. The coin dispenser may dispense rolled coins, loose coins, or both. It is also contemplated that the dispensing unit 222 may be adapted to dispense both bills and coins. These features may be advantageous to have in the remote banker 100a because they allow the remote banker 100a to be used as an ATM. A customer may use the remote banker 100a to open a new account and also to deposit, withdraw, and transfer funds, all of which may be done in a manner similar to that in an ATM.

A controller 210 manages the operation of the remote banker 100a. The controller 210 directs the flow of documents from the input receptacle 216 through the transport mechanism 218, past the scanner 212 and the discrimination and authentication unit 214, and into one of the output receptacles 220a-n or back to the input receptacle 216. The transport mechanism 218 may direct a document 281 through the remote banker 100a such that the document 281 is transported such that it is scanned along a direction parallel to its narrow dimension. Alternatively, the document 281 may be transported through the remote banker 100a such that it is scanned along a direction parallel to its wide dimension. The controller 210 may also direct the dispensing unit 222 to dispense funds to the customer and route information from the scanner 212 and/or the discrimination and authentication unit 214 to an interface 224 outside the remote banker 100a. The electronic pen and keypad may also act as a signature acquisition device, enabling the remote banker to receive a person signature from the customer.

The interface 224 may also be adapted to accept data from an outside accounting system (discussed below) and transmit the data to the controller 210. The interface 224 may also be in communication with a processor 215. The processor 215 is at a location separate from the remote banker 100a (e.g., the bank office 160 shown in FIG. 3) and receives data, such as images, from the interface 224. By connecting the remote banker 100a to the processor 215, the system may be able to process transactions substantially immediately. For example, according to some embodiments, deposits may be processed in real time, rather than waiting for the end of the day. The remote banker 100a may be adapted to credit an account with a deposited amount minutes after the deposit is made.

Also, in some embodiments, full or partial images of all documents can be stored in one or more mass storage devices 217 at the bank office 160. The mass storage devices 217 may be searchable by the remote banker 100a. For example, as described in FIGS. 1 and 2, in some embodiments the first image is obtained by searching a history for the customer. The history may be stored in the mass storage device 217 and may include images of the customer, the customer's signature, and biometric data. Other embodiments contemplate that the images are stored at the unit 100a (shown in FIG. 3) or at another remote system. In some embodiments, the images can also be temporarily stored at the remote banker 100a, and forwarded at a later time.

It is also contemplated that a personal computer 211 may be linked to the interface 224. The personal computer 211 can process data from the scanner 212. Processing of scanned data can occur at the personal computer 211, within the scanner 212 and/or the discrimination unit 214, the controller 210, or at the processor 215. Processing of scanned data may include evaluating image quality, storing the data, comparing the data to other data, updating records relating to the data (e.g., account balances), and opening new accounts based on the data.

A customer interface 226 may also be coupled to the controller 210. The interface 226 displays information to the customer and accepts customer commands. FIG. 5 provides a more detailed view of an example of the interface 226. FIG. 5 is a perspective view of an embodiment of the remote banker 100a, in which the remote banker is an ATM. As shown, the interface 226 may consist of a display screen 250, such as a video screen, onto which information for the customer may be displayed by the remote banker 100a. The interface 226 may also include a keyboard 252 for accepting commands from the customer. In another embodiment, the display screen 250 may be a touch screen, and the customer interface 226 may be the touch screen or a combination of the touch screen and the keyboard 252. It is also contemplated that dedicated buttons 253 may be located adjacent to the display screen 250, as commonly done on ATMs. In some embodiments, the display screen 250 may act as an electronic pad, capable of receiving instructions from an electronic pen 251 located adjacent to the screen 250.

The interface 226 may also be adapted to allow two-way communication between a customer and an operator. The interface 226 may include an audio microphone 264a and a speaker 264b located on the remote banker 100a. The microphone 264a and the speaker 264b are communicatively linked with the operator at the financial institution much in the same way a microphone and speaker work in a drive-through teller. Thus, during the operating hours of a financial institution, the operator may be connected to the system via the audio microphone 264a and the speaker 264b.

The processor 215 may also have a video terminal (not shown) associated therewith. The video terminal may be adapted to receive and display images, such as full video images of the documents input into the remote banker 100a. If the documents are not recognizable by the processor 215, the document image may be forwarded to the operator for observation on the video terminal.

In the case of identification-type documents, if the discrimination and authentication unit 214 cannot authenticate the documents, images of the identification-type document may be used to verify authenticity. Also, the video screen may be used to allow the operator to compare the photograph image to the image of the customer and the two signature images as discussed in FIGS. 1 and 2. Likewise, the image of a document to be deposited, e.g., currency bill and/or check, may be displayed on the screen and the operator can then discuss the document with the customer. In such a case, the operator may decide to accept the document immediately for credit after reviewing the image on the terminal.

With a full image scan, enough information may have been scanned on an unrecognizable document that review by the operator on the terminal will enable the operator to accurately discern the required information from the document. Additionally, the image of a document may be presented on a separate monitor located at a terminal used by the operator. By reviewing the data, the operator may be able to enter missing data via a keyboard or other input means if the image is recognizable. If the operator is near the remote banker 100a and an image on the monitor is unclear, the operator may remove the document from the scanner 212 and/or remote banker 100a, inspect the document, and enter the missing data. The value and other information may also be entered by denomination keys and an alphanumeric keypad, as described below, or with a mouse and applications software. Additionally, the value may be entered by a touch screen device or by any combination of the input devices described above. The document may then be placed back in the remote banker, such as in an output receptacle 220 and the process continued. In some situations, the customer may enter the value or other information concerning the unidentified documents. This entry may be via the keyboard or touch screen and credit may be given to the customer's account after the document is verified by bank personnel. In other situations, the document may be returned to the customer along with a statement indicating why the document could not be processed.

According to one embodiment shown in FIG. 5, the remote banker 100a has a slot 254 which is adapted to receive a customer's identification card, or first identification-type document, which may be a debit card, smart card, ATM card, or identification card issued by the bank. In another embodiment, the customer's identification card may also be a driver's license, a passport, or a state identification card. In other embodiments, the remote banker 100a does not include the slot 254, but is instead activated by performing a biometric scan, which identifies the customer. The customer inserts the card into the slot 254 to access the remote banker. The slot 254 may include a customer identification reader, such as a magnetic strip reader. The magnetic strip reader, such as those used in standard ATMs, is adapted to read code from a debit or a credit card that has been inserted into the remote banker 100a. Additionally, the magnetic strip reader may also be adapted to obtain customer identification information from other types of documents, such as driver's licenses or other customer identification documents. The customer may deposit other documents into a bin 256. The bin 256 may be adapted to accept documents, such as a signature card, passport, loose bills, or checks in a deposit that need to be scanned. In the instance of a customer desiring to open a new account, the customer may insert currency bills and/or negotiable instruments into the bin 256 for deposit into the new account. Loose bills may be dispensed from a dispenser 258, strapped currency may be dispensed from a receptacle 260, and loose or rolled coins may be dispensed from a coin receptacle 262. It is also contemplated that a coin acceptance slot 266 and a coin sorter (see FIG. 4) may be included, as well.

The remote banker 100a of FIG. 5 also includes a camera lens opening 255. The camera lens opening 255 is the opening for the camera 205 described above in FIG. 4. Through the camera lens opening 255, the camera 205 obtains the live image of the customer.

Other modules can be added to the system. For example, a smart card acceptance module 263 may be provided for accepting smart cards. A smart card dispensing module 265 may also be provided for dispensing smart cards. In one embodiment, the smart card dispenser and the smart card acceptance module are the same opening. An optical reader module 257 may also be provided for accepting and dispensing optical media.

In some embodiments, the system may also include the biometric scanner 208 described in FIG. 4. The biometric scanner 208 may include an opening 270 for the scanner 208 to obtain a scan of the customer's retina. Alternatively, the biometric scanner 208 may include a touch pad 272 for receiving the customer's thumbprint.

The additions of the coin acceptance slot 231 and coin sorter 232 (shown in FIG. 4) will additionally provide customers with a method for depositing large amounts of coins easily, or just sorting and counting them by denomination for convenience. In some embodiments, it is beneficial that the remote banker have all of these additional features because it can be used for a variety of functions, enabling a customer to do many banking functions from one location.

Returning now to the description of the remote banker 100a of FIG. 4, the output receptacle 220a-n can be a single bin into which all documents transported by the transport mechanism 218 are deposited. In one embodiment, the remote banker 100a has two output receptacles 220a, 220b as shown in phantom in FIG. 4. In the case of two output receptacles 220a, 220b, according to one embodiment, identifiable documents may be placed into the first output receptacle 220a and unidentifiable documents may be placed into the second output receptacle 220b. Additionally, as shown in phantom in FIG. 4, any number of output bins can be used to receive the documents. For example, currency of particular denominations can be received in separate bins. For example, one bin each can be used to receive $1, $5, $10, $20, $50, and $100 bills. In other embodiments, one or more of the bins may be used to receive currency bills and another may be used to receive checks.

In another embodiment, the scanner can be used without the discrimination unit and with a single output receptacle. In one embodiment, the scanner 212 can be used in the remote banker 100a without the discrimination unit 214 and with two output receptacles or bins 220a, 220b. In another embodiment, the scanner 212 can be used in the remote banker 100a without the discrimination unit 214 and with a plurality of output receptacles or bins 220a-n.

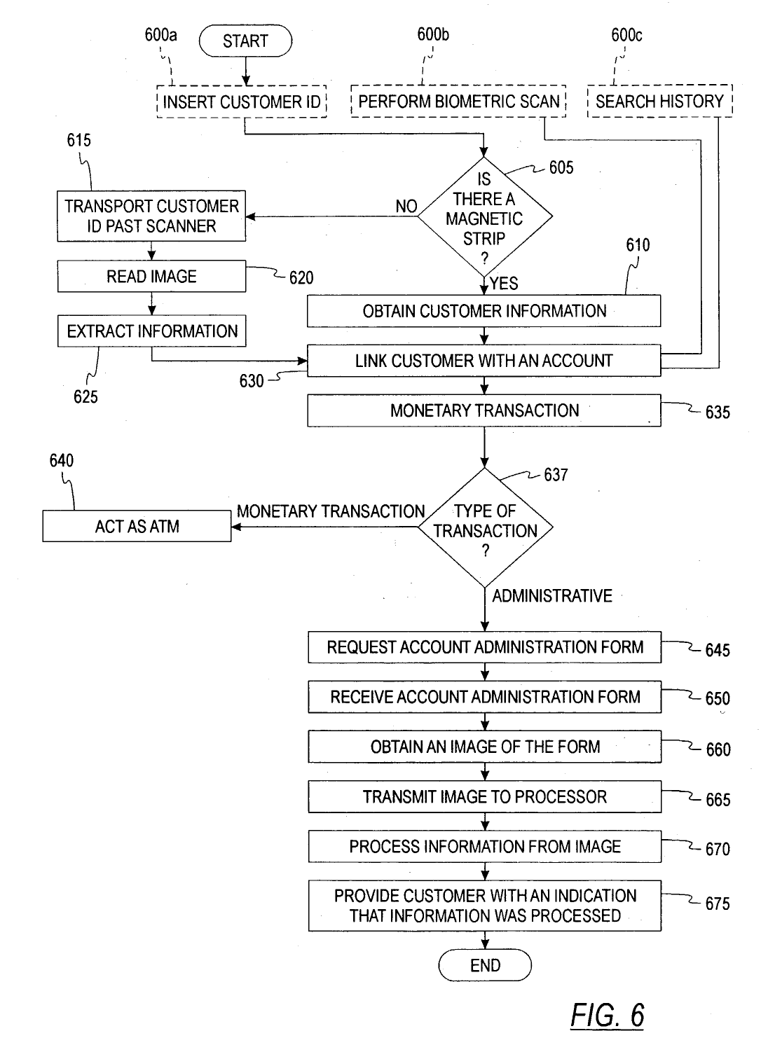

So far, some aspects of the present invention have been described in reference to opening a new account. However, the remote banker 100a may also be used to perform other administrative functions, such as closing an existing account, changing the customer's address on the account, and changing signers on the customer's account. The process of these functions will now be described in detail in relation to FIG. 6.

FIG. 6 is a flow chart illustrating the process of-using the remote banker 100a to perform various administrative and financial functions. As shown in step 600a, the user inserts a customer identification card into the slot 254. Most commonly, the identification card 254 will be a bank debit or credit card, although it also may be a driver's license or state identification card. At step 605, a magnetic strip reader searches for a magnetic strip on the identification card. If one is found, the remote banker proceeds to step 610, and the remote banker reads the magnetic strip, obtaining the customer identification information.

If a magnetic strip does not exist on the card, the remote banker 100a transports the card past the document scanner for imaging (step 615). The scanned image is then read at step 620 and the customer identification information is extracted (step 625).

Alternatively, the process may begin at step 600b, in which the customer is identified by obtaining a biometric scan. The biometric scan may include obtaining a fingerprint or a retinal scan, although other types of biometric scans may also be used. The information from the biometric scan is used to obtain customer identification information. In other embodiments, the process begins at step 600c, in which a storage device is searched for images of the customer in order to obtain customer identification information.

After the customer identification information is extracted, the process advances to step 630, and the processor links the customer identification information with the account or accounts associated with the customer. Next at step 635, the remote banker requests information from the customer regarding the type of transaction the customer would like to make. If the customer chooses to perform monetary transactions (e.g. balance inquiry, withdraw funds, deposit funds, or transfer funds between accounts), the remote banker proceeds to step 640, and acts as a traditional ATM.

The customer may also choose to do administrative functions, such as close an existing account, change customer information on the account, and/or change signers on an account. If the customer chooses to do an administrative function, the remote banker would then request an account administration form from the customer at step 645. The account administration form may be filled out on a printed form that is kept near the remote banker 100a. Alternatively, the account administration form may be an electronic form that is presented to the customer on the display screen (250 in FIG. 5). The customer may enter in information into the remote banker 100a using a keyboard, a keypad, touch screen, electronic pen, or any other known input mechanism.

After the customer inserts the account administration form or otherwise inputs the form into the banker (step 650), the remote banker obtains an image of the form (step 660). The document scanner transmits the image of the form to a processor at step 665. The processor, using imaging software such as OCR as described above, processes the information within the account administration form at step 670. This includes deciphering what type of function the customer would like to have done and reading the information within the change. For example, the customer may fill out a form to indicate that he would like to change the address associated with the account. The processor would extract the address change information and update the account associated with the customer so that the new address is listed as the correct address for this account. Once the processor has accepted the change, a receipt or other form of acknowledgment would be presented to the customer at step 675.

While this embodiment discussed doing an address change, the remote banker may also perform functions associated with performing other administrative tasks, such as closing an account and adding or deleting signers. If the customer wishes to close an account, this section of the administration form will indicate which account the customer desires to close and, if there are funds in the account, how the funds should be disbursed. In some embodiments of the present invention, the processor may check the account's balance. If a positive balance exists, the form may indicate how the customer wants the balance disbursed. In other embodiments, the remote banker may ask the customer for instructions as to how the balance should be disbursed. The instructions may be input via a touch pad, number pad, keypad, or any other input device as described above in FIG. 4. If a negative balance exists (i.e., if the account is overdrawn), the processor may not close the account and, the remote banker will indicate to the customer that the account cannot be closed because of an overdrawn balance. In some instances, the bank may decide that the account can be closed even if a negative balance exists, and the rules for this may be input into the processor.

If the customer wishes to add or delete a signer from the account, the customer will have to fill out the signature change form. Often times, the signer who is being added or deleted will have to be present to sign the form. The signature of the new/deleted signer can be authenticated as the signature is verified in opening a new account described above.

In addition to embodiments described above or in the accompanying claims, several embodiments of the present inventions and how these embodiments will be used will now be described.

Embodiments

Following are a series of examples of how a customer may use the financial institution terminal. Unless otherwise noted, the description will relate to FIGS. 4 and 6.

In this first example, a description of remote banker utilizing an identification card and an image to identify a customer will be described. The customer will indicate on the financial institution terminal, or remote banker, 100a the function that they wish to perform. This may be done by activating a button 253, pressing a touch screen portion of the display screen, and/or by typing in a response on the keyboard 252 in response to an inquiry on the remote banker 100a. The remote banker 100a may then request that the customer insert a customer identification card, or personal identification card, such as a driver's license or state identification card into the slot 254 for processing. The slot 254 may include a personal identification card reader, such as a magnetic code reader which would obtain personal identification information from the customer. This may include name, address, and phone number. The card is then imaged by a document imaging device 212. As described above, the document imaging device 212 obtains an image of a photograph on the personal identification card and a signature on the card.

The remote banker 100a also obtains a live image (i.e., real-time image) of the customer using an image taking device, or camera, 205 through the lens 255 of the remote banker 100a. The person image, or live image, and the document image are transported to a processor 160, which then compares the images.

The remote banker 100a also obtains a signature on a signature acquisition device. The signature acquisition device may include an electronic pen 251 which works in conjunction with a portion of the display panel 250 to allow the customer to write a signature on the display panel 250. The signature will then be lifted from the display panel 250 and stored for use. Alternatively, the signature acquisition device may include a signature card which is signed by the customer and then inserted into the slot 254 for scanning by the document imager.

In both instances, the person signature is compared with an image of the signature from the identification document. If both the signatures and the photograph images appear to be of the same person, then the processor 160 will perform the function requested, e.g., open a new account, change an address, etc. A printed receipt may be dispensed from a printer 259c, indicating that the function has been performed. Alternatively, the receipt may be mailed and/or e-mailed to the customer.

In another embodiment, instead of obtaining a live image, the remote banker 100a could instead obtain biometric data using the biometric scanner or sensor 208. The remote banker 100a may request that the user place his finger or thumb on the biometric scanner 208, which in this case would be a finger print scanner. The biometric scanner 208 obtains the finger print and compares information linked to the finger print with information on the personal identification card. The personal identification card may only list information such as name, address, social security number, and phone number. In this case, the remote banker would have to search a the mass storage 217 for personal information that matches the finger print. If the result from the search matches the information on the card, the function is performed. Alternatively, the personal information card may include the biometric data of the rightful owner of the card and this information may be read by the card reader. If the biometric data on the card matches the biometric data obtained by the scanner 208, then the function requested by the customer is performed.

In another embodiment, the biometric data may be used in conjunction with a stored biometric data. For existing customers, the financial institution may store biometric data in the mass storage 217. When a customer desires to perform a function at the remote banker 100a, the remote banker 100a obtains the customer's biometric data via the biometric scanner 208. The current biometric data is compared with the stored biometric data. If the two data match, then the function can be performed.

In other embodiments, the live image may be compared to a stored image of the customer. The mass storage 2317 may be used to store images of existing customers. When an existing customer requests a function from the remote banker 100a, a live image is obtained via the camera 205. The user inserts a bank card to provide personal identification information. The identification information is used to link the account with a stored image in the mass storage 217. The live image is then compared by the processor 160 with the stored image that is associated with the account. If the live image matches the stored image, then the request is processed and the function is performed.

What it claimed is:

1. A financial institution system, comprising:
a financial institution terminal including a document imaging device that obtains an image of a personal identification document which includes associated therewith a photograph of a person and an image taking device that obtains an image of a person who presented the personal identification document to the financial institution terminal; and
a processor that receives the document image and person image from the financial institution terminal for review and further operates to perform a financial institution function requested by the person if it is determined that the photograph in the document image and the person image appear to be of the same person.

2. The financial institution system of claim 1, wherein the financial institution terminal includes a camera as the image taking device.

3. The financial institution system of claim 2, wherein the camera produces a video image of the personal identification document.

4. The financial institution system of claim 2, wherein the camera produces a digital image of the personal identification document.

5. The financial institution system of claim 1, wherein the financial institution function is a financial institution administrative function.

6. The financial institution system of claim 5, wherein the financial institution administrative function is the opening of a new account.

7. The financial institution system of claim 6, wherein the processor further functions to establish the new account for the person and the financial institution terminal functions to convey new account identification information to the person.

8. The financial institution system of claim 7, wherein the financial institution terminal includes means for receiving a monetary deposit in association with the opening of the new account.

9. The financial institution system of claim 8, wherein the monetary deposit is a cash deposit.

10. The financial institution system of claim 8, wherein the monetary deposit is an electronic funds transfer.

11. The financial institution system of claim 8, wherein the monetary deposit is a negotiable instrument deposit.

12. The financial institution system of claim 1, wherein the processor operates to perform a comparison between the photograph in the imaged document and the person image and further decides based on that comparison whether the photograph in the document image and the person image appear to be of the same person.

13. The financial institution system of claim 1, wherein the processor receives human input from bank personnel as to whether the photograph in the document image and the person image appear to be of the same person.

14. The financial institution system of claim 1, wherein the personal identification document also includes associated therewith a signature of the photographed person;
the financial institution terminal further including a signature acquisition device that obtains a signature of the person who presented the personal identification document to the financial institution terminal; and
the processor receiving the document image and person signature from the financial institution terminal for review and further operates to perform the financial institution function requested by the person if it is determined that the signature in the document image and the person signature appear to be made by the same person.

15. The financial institution system of claim 14, wherein the processor operates to perform a comparison between the signature in the imaged document and the person signature and further decides based on that comparison whether the signature in the document image and the person signature appear to be made by the same person.

16. The financial institution system of claim 14, wherein the processor receives human input from bank personnel as to whether the signature in the document image and the person signature appear to be made by the same person.

17. The financial institution system of claim 14, wherein the signature acquisition device comprises the document imaging device which is operable to image a signature card to obtain the person signature.

18. The financial institution system of claim 14, wherein the signature acquisition device comprises an electronic signature pad associated with the financial institution terminal.

19. The financial institution system of claim 1, wherein the financial institution terminal comprises a conventional financial institution automated teller machine (ATM).

20. The financial institution system of claim 1, wherein the financial institution terminal additionally performs financial institution functions associated with the operation of an automated teller machine (ATM).

21. The financial institution system of claim 1, further including a storage device for storing at least the person image in association with an account of that person, the image taking device of the financial institution terminal further obtaining a current image of a person requesting access to the account, the processor operating to allow access to the account as requested by the person if it is determined that the stored person image and the current person image appear to be of the same person.

22. The financial institution system of claim 21, wherein the processor operates to perform a comparison between the stored imaged and the current person image and further decides based on that comparison whether the stored image and the current person image appear to be of the same person.

23. The financial institution system of claim 21, wherein the processor receives human input from bank personnel as to whether the stored image and the current person image appear to be of the same person.

24. The financial institution system of claim 21, wherein the financial institution function comprises a financial institution administrative function performed against the accessed account.

25. The financial institution system of claim 1, wherein the financial institution terminal is remotely located from the processor.

26. The financial institution system of claim 25, wherein the financial institution terminal is located outside a bank office and the processor is located inside the bank office.

27. The financial institution system of claim 1, wherein the financial institution terminal further includes an authentication device operable to authenticate the personal identification document as a prerequisite to performing the financial institution function requested by the person.

28. The financial institution system of claim 1, wherein the personal identification document is a driver's license.

29. The financial institution system of claim 1, wherein the photograph is viewable on a surface of the personal identification document.

30. The financial institution system of claim 1, further including a network communications link connecting the financial institution terminal to the processor.

31. A method for performing an operation at a financial institution system, comprising:
obtaining an image of a personal identification document at a financial institution terminal, the personal identification document including a photograph of a person;
obtaining an image of a person who presented the personal identification document to the financial institution terminal by a document imaging device;
transmitting the document image and person image from the financial institution terminal to a processor;
determining whether the photograph in the document image and the person in the person image appear to be of the same person;
performing a financial institution function requested by the person if it is determined that the photograph in the document image and the person in the person image are the same person.

32. The method of claim 31, wherein the step of obtaining the image of a person comprises providing a camera to obtain the image.

33. The method of claim 32, wherein the step of obtaining the image of a person comprises obtaining a video image of the personal identification document.

34. The method of claim 32, wherein the step of obtaining the image of a person comprises obtaining a digital image of the personal identification document.

35. The method of claim 1, wherein the step of performing a financial institution function comprises performing a financial institution administrative function.

36. The method of claim 35, wherein the step of performing a financial institution administrative function comprises the opening of a new account.

37. The method of claim 36, further comprising establishing the new account for the person and conveying new account identification information to the person.

38. The method of claim 37, further comprising receiving a monetary deposit in association with the opening of the new account.

39. The method of claim 38, wherein the step of receiving the monetary deposit comprises receiving a cash deposit.

40. The method of claim 38, wherein step of receiving the monetary deposit comprises receiving an electronic funds transfer.

41. The method of claim 38, wherein the step of receiving the monetary deposit comprises receiving a negotiable instrument deposit.

42. The method of claim 1, wherein the step of determining whether the photograph in the imaged document and the person in the person image are the same person comprises the step of performing a comparison by the processor and deciding, by the processor, based on that comparison, whether the photograph in the document image and the person image appear to be of the same person.

43. The method of claim 31, wherein the step of determining whether the photograph the in the imaged document and the person in the person image are the same person further comprises receiving human input from bank personnel as to whether the photograph in the document image and the person image appear to be of the same person.

44. The method of claim 31, further comprising:
obtaining a signature from the document image;
obtaining a second signature from a signature acquisition device that obtains a signature of the person who presented the personal identification document to the financial institution terminal; and
transmitting the document image and person signature from the financial institution terminal to the processor;
comparing the signature from the document image and the person signature; and
performing the financial institution function requested by the person if it is determined that the signature in the document image and the person signature appear to be made by the same person.

45. The method of claim 44, wherein the step of determining whether the signature in the imaged document and signature image are made by the same person comprises the step of performing a comparison by the processor and deciding, by the processor, based on that comparison, whether the signature in the document image and the signature image appear to made by the same person.

46. The method of claim 44, wherein the step of determining whether the signature in the imaged document and the signature image are made by the same person further comprises receiving human input from bank personnel as to whether the signature in the document image and the person signature appear to be made by the same person.

47. The method of claim 44, wherein the step of obtaining the person signature comprises obtaining an image a signature card by the document imaging device to obtain the person signature.

48. The method of claim 44, wherein the obtaining the person signature comprises receiving the signature on an electronic signature pad associated with the financial institution terminal.

49. The method of claim 31, further comprises performing financial institution functions associated with the operation of an automated teller machine (ATM).

50. The method of claim 31, further comprising:
storing at least the person image in association with an account of that person;
obtaining a current image of a person requesting access to the account;
determining whether the stored person image and the current person image are of the same person;
allowing access to the account as requested by the person if it is determined that the stored person image and the current person image appear to be of the same person; and
performing a financial institution function requested by the person if access has been allowed.

51. The method of claim 50, wherein the step of determining that the stored image and the current person image processor are of the same person comprises performing a comparison, by the processor, between the stored imaged and the current person image and deciding, based on that comparison, whether the stored image and the current person image appear to be of the same person.

52. The method of claim 50, wherein the step of determining that the stored image and the current person image processor are of the same person comprises receiving human input from bank personnel as to whether the stored image and the current person image appear to be of the same person.

53. The method of claim 50, wherein the step of performing a financial institution function comprises performing a financial institution administrative function against the accessed account.

54. The method of claim 31, comprising remotely locating the financial institution terminal from the processor.

55. The method of claim 54, wherein the step of remotely locating the financial institution comprises locating the financial institution terminal outside a bank office and locating the processor inside the bank office.

56. The method of claim 31, further comprising authenticating the personal identification document as a prerequisite to performing the financial institution function requested by the person.

57. A system, comprising:
a financial institution terminal including a customer identification reader that obtains a customer identification information from a customer identification card and a person characteristic acquisition device that obtains personal characteristic information regarding a person who presented the customer identification card to the financial institution terminal; and
a processor that receives the customer identification information and personal characteristic information from the financial institution terminal for review and further operates to perform a financial institution function requested by the person if it is determined that the customer identification information and personal characteristic information are consistent with each other.

58. The system of claim 57, wherein the customer identification reader is a document imaging device and the customer identification card includes associated therewith a photograph of a person which is obtained by the document imaging device, and wherein the person characteristic acquisition device is an image taking device that obtains an image of a person who presented the customer identification card to the financial institution terminal, and further wherein the processor receives the photograph image and person image from the financial institution terminal for review and further operates to perform the financial institution function requested by the person if it is determined that the photograph image and the person image appear to be of the same person.

59. The system of claim 57, wherein the customer identification reader is a card reader and the customer identification card includes associated therewith reference biometric data which is obtained by the card reader, and wherein the person characteristic acquisition device is a biometric sensor that obtains person biometric data of a person who presented the customer identification card to the financial institution terminal, and further wherein the processor receives the reference and person biometric data from the financial institution terminal for review and further operates to perform the financial institution function requested by the person if it is determined that the person biometric data is consistent with the reference biometric data.

60. The system of claim 57, wherein the customer identification reader is a card reader and the customer identification card includes associated therewith a reference image which is obtained by the card reader, and wherein the person characteristic acquisition device is an image taking device that obtains an image of a person who presented the customer identification card to the financial institution terminal, and further wherein the processor receives the reference image and the person image from the financial institution terminal for review and further operates to perform the financial institution function requested by the person if it is determined that the reference image and the person image appear to be of the same person.

61. The system of claim 57, further including a storage device for storing a reference image of persons having an account, wherein the customer identification reader is a card reader and the customer identification card includes associated therewith an account identification, and wherein the person characteristic acquisition device is an image taking device that obtains an image of a person who presented the customer identification card to the financial institution terminal, and further wherein the processor retrieves the stored reference image associated with identified account and receives the person image from the financial institution terminal for review and further operates to perform the financial institution function requested by the person if it is determined that the reference image and the person image appear to be of the same person.

62. The system of claim 57, wherein the customer identification reader is a document imaging device and the customer identification card includes associated therewith a signature of a person which is obtained by the document imaging device, and wherein the person characteristic acquisition device is a signature acquisition device that obtains a signature of the person who presented the personal identification document to the financial institution terminal, and further wherein the processor receives the document image and person signature from the financial institution terminal for review and further operates to perform the financial institution function requested by the person if it is determined that the signature in the document image and the person signature appear to be made by the same person.
